(19) United States
(12) Patent Application Publication
(10) Pub. No.: US 2023/0061791 A1
(43) Pub. Date: Mar. 2, 2023

(54) GRIN LENSES MADE BY 3D PRINTING MONOMER-BASED INKS

(71) Applicant: Vadient Optics LLC, Beaverton, OR (US)

(72) Inventors: Edward Whitney Elliott, III, Eugene, OR (US); Sergiu A. Coporan, Eugene, OR (US)

(73) Assignee: Vadient Optics LLC, Beaverton, OR (US)

(21) Appl. No.: 17/403,300

(22) Filed: Aug. 16, 2021

(51) Int. Cl. C09D 11/38; C09D 11/101; G02B 1/04; G02B 3/00

(52) U.S. Cl. CPC C09D 11/38; C09D 11/101; G02B 1/041; G02B 3/0087; B33Y 70/00

(57) ABSTRACT

The present disclosure discloses an optical ink matrix comprising a UV polymerizable monomer, at least a first multifunctional monomer. The optical ink matrix may further comprise a second multifunctional monomer. The present disclosure further discloses a method of manufacturing non-axially symmetric GRIN lens using 3D printing.

### TECHNICAL FIELD OF THE DISCLOSURE

The present disclosure relates generally to optical ink compounds. More specifically, it relates to inkjet-printable optical ink compositions suitable for 3D printing of gradient refractive index (GRIN) optical components.

### BACKGROUND DISCUSSION

One major advantage to the 3D printing approach is the ability to fabricate non-axially symmetric GRIN optics and the ability to vary the GRIN in both the x,y and z directions broadening the design space of the optical components. While this approach to 3D printing of GRIN optical components has been reduced to practice by Vadient LLC as described in US patent number 20180022950 it is challenging to balance the rheological requirements of 3D inkjet printing and the optical requirements to obtain high quality GRIN optical components. In particular, the addition of dopants to the host matrix greatly increases viscosity and density, impairing the ability to inkjet print the resulting materials. As a result, even with other factors may be resolved, this approach is limited in the optical power that may be obtained using the aforementioned composite materials. Improvements in optical power may be obtained by the use of unique monomers in each ink formulation; however, this approach introduces additional challenges in material compatibility as they are deposited by inkjet printing for form GRIN optical components, resulting in material separation prior to cure obviating the advantages provided by the greater difference in refractive index between the inks.

### SUMMARY OF THE DISCLOSURE

The present disclosure is directed to optical inks suitable for 3D printing fabrication of gradient refractive index (GRIN) optical components which are composed of one (or more) monomer(s), wherein the ink has a viscosity less than 20 cPoise at the temperature of the printhead (between 20° C. and 80° C.) and is UV curable to form a solid polymer. Two (or more) miscible inks are used in tandem to create an ink set with dissimilar refractive index (>0.02) (specifically phase velocity, the real portion of the refractive index) by varying the composition of the monomers, or the ratio of the monomers in a mixture, between the inks. The monomers are designed/selected such that the resulting polymerized material has a crosslink density greater than 1×10⁻⁴ mol/cm³. The most general embodiment, any UV curable monomer can be used within the class of vinyl, acrylate, methacrylate or urethane. In one embodiment, the difference in refractive index is achieved by using two or more monomers with different refractive indices in each ink, and then varying the ratio of the monomers between the two inks. In another embodiment, each ink is composed of a single multifunctional monomer with different refractive index. Ideal embodiments use monomers containing phenyl functionality or hetero-atoms such as sulfur or halogens to raise the refractive index above that which can be achieved by monomers containing only C, O, and H, and monomers containing fluorine to lower the refractive index below that which can be achieved in monomers containing only C, O, and H.

### BRIEF DESCRIPTION OF THE DRAWINGS

The accompanying drawings, which are incorporated in and constitute a part of the specification, schematically illustrate embodiments of the present disclosure, and together with the general description given above and the detailed description of preferred methods and embodiment given below, serve to explain principles of the present disclosure.

FIG. 1A is a schematic of an example optical ink matrix.

FIG. 1B is a schematic of an example multifunctional monomer.

FIGS. 2A-B shows exemplary embodiments of molecular structures of multifunctional monomers.

FIG. 3 shows a flowchart of an example method of making a GRIN lens comprising multifunctional monomers.

FIG. 4 shows a flowchart of an example method of making a GRIN lens comprising a mono-functional monomer.

### DETAILED DESCRIPTION

Embodiments of the present disclosure include optical inks suitable for use in fabricating GRIN lenses using 3D printing technology such as standard drop-on-demand inkjet printing. These inks may also be used to fabricate GRIN lenses using other printing techniques such as screen printing, tampo printing, aerosol jet printing, and laser cure printing. Optical inks prepared according to the embodiments of the present disclosure are composed of monomers or blends of monomers with photoinitiators enabling polymerization by UV (or visible light or other ionizing radiation sources) with rheological properties suitable for 3D additive manufacture. Each of the monomer-based inks are placed in adjacent inkjet printheads. The number of inks, and adjacent printheads, is at least two, and other printheads may be used to incorporate additional inks with different optical properties (e.g. varied refractive indices or chromatic dispersions). Drop-on-demand inkjet printing technology is used to create microscopic features on-the-sample in order to precisely control the placement of highly-localized regions of varied refractive index, controlled by the mixture of the relatively high or low refractive index inks. The localized composition in three dimensions is controlled by the placement and number of drops of each ink and the amount of time allowed for diffusion controlled mixing following drop placement before locking the structure in place by polymerization. Each droplet of monomer deposited onto the substrate in order to form a GRIN optical element can be created by varying the desired concentration of high and low index monomers by varying the number of drops, and thus volume, of each of the two (or more) inks being used. The volumetric concentration of each of the inks within a given volume of the optical component determines the effective refractive index of a three-dimensional structure. The creation of precise three-dimensional optical lenses and other optical structures by stereolithography is known to those skilled in the art of GRIN lens design. Embodiments of the present disclosure provide inks suitable for the practical realization of such 3D printable inks for high quality GRIN lens fabrication. These inks provide the ability to control the index of refraction in three dimensions for creating large, localized index changes while maintaining high optical transmission and freedom from deleterious scattering phenomena that arise from feature sizes approaching λ/10, where λ is the wavelength of light that is desired to be manipulated by the optical element. Further these inks provide rapid diffusion of the monomers of varied refractive index, allow for rapid smoothing of features introduced by the relatively large size (dimensions greater than the wavelength of light being focused) of the drops as deposited in order to obtain GRIN optical elements with superior optical properties. This rapid diffusion of the ink components (relative to components found in other optical inks, such as nanoparticles or other inorganic clusters) allows for more rapid fabrication of the GRIN element as diffusion time, required to obtain smooth changes in the refractive index throughout the volume of the GRIN element that result in good optical quality, is greater than the time required for material deposition.

Since drop-on-demand inkjet may utilize multiple printheads with different loading of the index-changing dopant, the inks provided by the present disclosure may be used in various combinations with each other as well as with other optical inks, such as those described in US Patent 20180022950. This type of embodiment has been demonstrated (in the combination of the fluoroacrylate described with the material described in 20180022950.

According to embodiments of the present disclosure, an optical ink is composed of a monomer, or mixture of monomers that is polymerizable by UV/visible light or other ionizing radiation to provide a solid polymer. Preferably, the monomers used are such that UV curing results in a highly crosslinked material. Further, the monomers used in each of the inks used to fabricate the GRIN element are chosen such the shrinking is less than 20% and the relative shrinkage between the various inks is less than 10%, which serves to minimize deformation of the optical structure as well as minimizing stress/strain in the solid part to overcome limits in the dimension of the parts that may be fabricated. The GRIN element, once cured, has a transmittance of at least 80% (preferably >99%) at the wavelengths of interest (e.g., visible spectrum, or infra-red spectrum).

Referring now to the drawings, wherein like components are designated by like reference numerals. Methods of manufacture and various embodiments of the present disclosure are described further herein below.

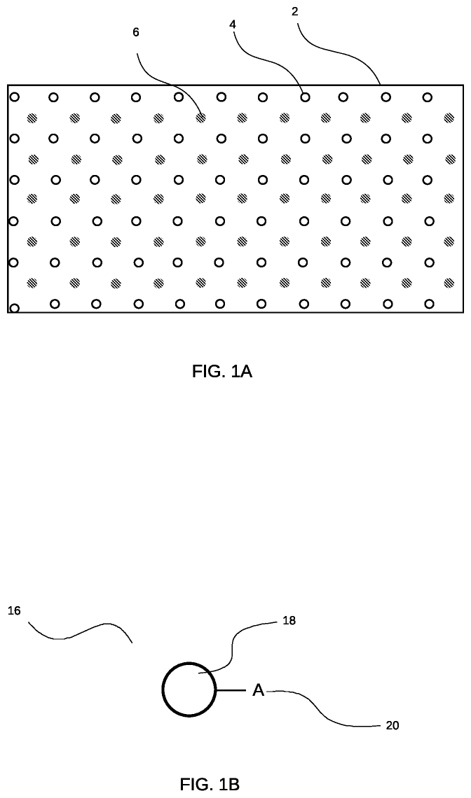

Referring to FIG. 1A, FIG. 1A shows an example schematic diagram of an optical ink matrix 2 of a gradient refractive index (GRIN) lens. The optical ink matrix 2 comprises a UV polymerizable monomer 4 and a multifunctional monomer 6. While the components of FIG. 1 show simple shapes, the monomers may take one different shapes. The UV polymerizable monomer 4 of the optical ink is chosen from a class of vinyl, methacrylate, and urethane. Thus, during polymerization of the UV polymerizable monomer, the resulting polymer may take on different shapes. It is important to note that the UV polymerizable monomer may also be cured by other means such as other types of radiation or by chemical means.

A first multifunctional monomer 6 may also be added to an optical ink matrix 2. The spherical shape of the first multifunctional monomer 6 in FIG. 1A is only for diagrammatic purposes and therefore does not have to represent the actual shape of the first multifunctional monomer 6. The first multifunctional monomer 6 may also be polymerized by a source of radiation. More specifically, the first multifunctional monomer 6 may be polymerized by UV radiation. A second multifunctional monomer may further be added to the optical ink matrix 2. The second multifunctional monomer, like the first multifunctional monomer may also be polymerized using UV radiation. The first and second multifunctional monomers may also have different refractive indices. In an example embodiment, on one end of a GRIN lens, one type of monomer is present while on another end of the same GRIN lens, another type of monomer is used thereby giving 2 regions of the same GRIN lens different refractive indices. This allows for refraction of light to be engineered in specific locations within the GRIN lens. Using 3D printing, different refractive indices may be engineered in different locations within the GRIN lens without it being axially symmetric.

Referring to FIG. 1B, FIG. 1B shows an example schematic diagram of a multifunctional monomer 16 comprising a monomer part 18 and a functionalized part 20 represented by the letter A. The multifunctional monomer 16 may take on different shapes and the spherical shape depicted in FIG. 1B is used for diagrammatic purposes. The multifunctional monomer 16, of an optical ink matrix as shown in FIG. 1A, either acting as a first or second multifunctional monomer may take the form as presented in in FIG. 1B. More specifically, the multifunctional monomer may take on the following exemplary form having a low refractive index:

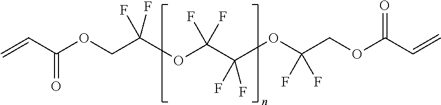

where the structure of molecule has fluorine as the functionalized parts 20 and n is a positive integer. The value of n may be controlled during the synthesis or polymerization process to control the viscosity of the optical ink matrix since the size of the molecule affects the viscosity. The multifunctional monomer may also take on another exemplary form:

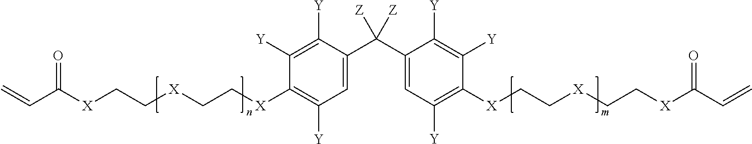

where X is Oxygen, Sulfur, or Nitrogen, Y is Hydrogen or a Halogen, Z is a Hydrogen, a Halogen, a Phenyl group, or an Alkane, and m is a positive integer.

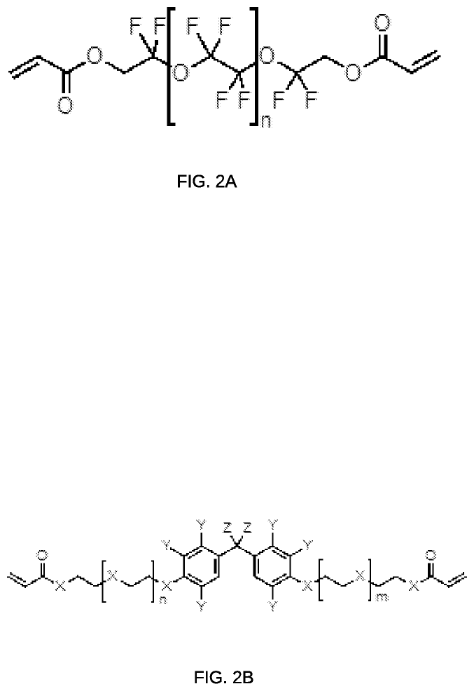

Referring to FIGS. 2A-B, FIGS. 2A-B show example multifunctional monomers mentioned in FIGS. 1A-B. In one example embodiment, a chemical composition may comprise a UV polymerizable monomer, a first and second optical ink, wherein each of the first and second optical inks comprises a multifunctional monomer, wherein the multifunctional monomer in the first optical ink has a different chemical structure than the multifunctional monomer in the second optical ink. The different chemical structures between the multifunctional monomers allow for a different in refractive indices. The multifunctional monomer in FIG. 2A, where the structure of molecule has fluorine as the functionalized parts 20 and n is a positive integer. The value of n may be controlled during the synthesis or polymerization process to control the viscosity of the optical ink matrix since the size of the molecule affects the viscosity. The multifunctional monomer may also take on another exemplary form as seen in FIG. 2B, where X is Oxygen, Sulfur, or Nitrogen, Y is Hydrogen or a Halogen, Z is a Hydrogen, a Halogen, a Phenyl group, or an Alkane, and m is a positive integer. Depending on whether the refractive index needs to be raised or lowered, the use of the structures in FIG. 2A or FIG. 2B may be used. The multifunctional monomer as shown in FIG. 2A comprising using monomers containing fluorine may lower the refractive index below that which can be achieved in monomers containing only C, O, and H. The multifunctional monomer as shown in FIG. 2B containing phenyl functionality may raise the refractive index above that which can be achieved by monomers containing only C, O, and H. Additionally, monomers containing hetero-atoms chosen from a list of hetero-atoms containing sulfur and halogens may raise the refractive index above that which can be achieved by monomers containing only C, O, and H.

One specific embodiment uses a high index ink comprising Benzyl Acrylate, Tricyclo[5.2.1.02,6]decanedimethanol diacrylate (TCMDA), pentaerythritol tetraacrylate (5.4:1:1 vol.) with 1% Irgacure 184 and 202 ppm BYK-UV-3500, having refractive index of 1.52. The low refractive index ink of this embodiment is ((perfluoroethane-1,2-diyl)bis(oxy))bis(2,2-difluoroethane-2,1-diyl) diacrylate with 3% wt. Irgacure 184, having a refractive index of 1.374. In yet another specific embodiment, the monomers may be used in concert with nanoparticles to further engineer the refractive indices of the resulting GRIN lens. For example, for a high refractive index ink, Neopentylglycol Diacrylate 89% and 11% ZrO₂ nanoparticles (vol.) may be used with 1% Iracure 184 and 250 ppm BYK-UV-3500, having a refractive index of 1.53. A low refractive index ink of for this example may use ((perfluoroethane-1,2-diyl)bis(oxy))bis(2,2-difluoroethane-2,1-diyl) diacrylate with 3% wt. Irgacure 184, having a refractive index of 1.374.

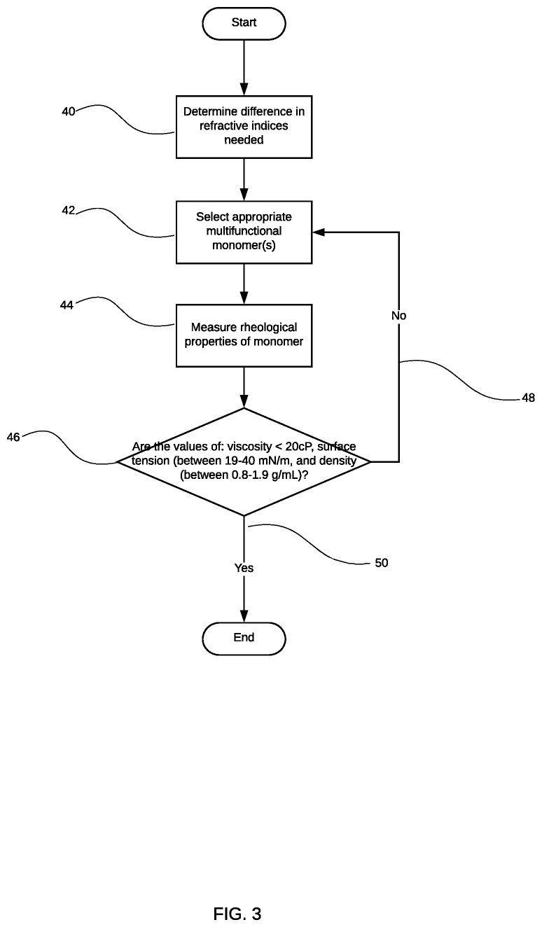

Referring to FIG. 3, FIG. 3 shows a flowchart of an example method of making a GRIN lens. The method in this figure is a preferred method wherein the appropriate multifunctional monomers may be used in an optical ink matrix 2 as shown FIG. 1A, for example. In step 40, a determination in differences in refractive indices is needed. A gradient refractive index map may be needed in this step to determine locations which the different multifunctional polymers may be 3D printed within the optical ink matrix 2 of a GRIN lens. In step 42, appropriate multifunctional monomers are selected. Monomers are selected based on predetermined refractive index differences. In an exemplary embodiment, the ratios of the multifunctional monomers may be varied to control rheological properties such that using monomers containing hetero-atoms chosen from a list containing sulfur and halogens to raise the refractive index above that which can be achieved by monomers containing only C, O, and H. The method further comprises using monomers containing phenyl functionality to raise the refractive index above that which can be achieved by monomers containing only C, O, and H. The method also comprises using monomers containing fluorine to lower the refractive index below that which can be achieved in monomers containing only C, O, and H. The monomers may be designed/selected such that the resulting polymerized material has a crosslink density greater than 1×10⁻⁴ mol/cm³. In step 44, once the optical ink matrix 2 contains all the necessary multifunctional monomers, rheological properties are measured to see if the values of these properties match up with predetermined desired values. In step 46, if the measured viscosity is less than 20 cP, the surface tension is measured to be between 19-40 mN/m, and the density is measured to be between 0.8-1.9 g/mL, then no further step may be needed as in step 50. However, if all the requirements in step 46 are not met, then a reselection of multifunctional monomers is needed as shown in step 48.

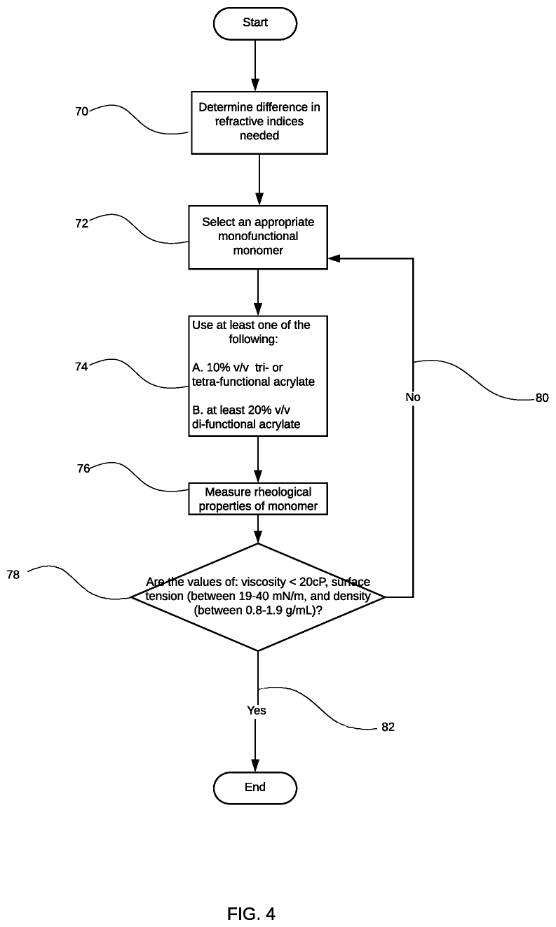

Referring to FIG. 4, FIG. 4 shows a flowchart of an example method of making a GRIN lens. The method in this figure is yet another example method. However, a mono-functional monomer may be used in an optical ink matrix 2 as shown FIG. 1A, for example. In step 70, a determination in differences in refractive indices is needed. A gradient refractive index map may be needed in this step to determine locations which the different multifunctional polymers may be 3D printed within the optical ink matrix 2 of a GRIN lens. In step 72, an appropriate mono-functional monomer is selected. Monomers are selected based on predetermined refractive index differences. In this method, since a monofunctional monomer is selected, at least one other multifunctional monomer is also selected. In step 74, either 10% v/v tri- or tetra-functional acrylate or at least 20% v/v di-functional acrylate is used in addition to a mono-functional monomer used in step 72. In step 76, once the optical ink matrix 2 contains all the necessary mono-functional and multifunctional monomer, rheological properties are measured to see if the values of these properties match up with predetermined desired values. In step 78, if the measured viscosity is less than 20 cP, the surface tension is measured to be between 19-40 mN/m, and the density is measured to be between 0.8-1.9 g/mL, then no further step may be needed as shown in step 82. However, if all the requirements in step 46 are not met, then a reselection process as in step 80 may be needed.

In addition to disclosed compositions and methods of non-axially symmetric GRIN lens, the present disclosure uses diffusion-controlled GRIN fabrication using monomers alone (rather than varying the amount of nanoparticles in a composite material) to achieve greater lens power by increasing the difference in refractive index between high/low index inks and improved optical quality by allowing smaller feature sizes and improving the speed of diffusion and therefore the rate at which GRIN optical components may be fabricated as diffusion time is the limiting bottle-neck in 3D printing of GRIN. However, an example embodiment may also include the use of nanoparticles to further engineer the optical features of the GRIN lens. The formulation of the high refractive index ink in this disclosure may help with compatibility with some monomers including FEGDA, further improving inkjet printability modifying formulations of GRIN ink in order to improve the compatibility of ink pairs while maintaining required rheological properties for inkjet printing.

From the description of the present invention provided herein one skilled in the art can manufacture the apparatus and practice the methods in accordance with the present disclosure. Those skilled in the art to which the present invention pertains will recognize that while above-described embodiments and method of manufacture are exemplified using particular materials, others may be combined using these embodiments without departing from the spirit and scope of the present invention. Although some of the embodiments explained above have certain symmetry one skilled in the art will recognize that such symmetry is not a requirement. In summary, the present invention is described above in terms of particular embodiments. The invention, however, is not limited to the embodiments described and depicted herein. Rather, the invention is limited only by the claims appended hereto.

I/We claim:

1. An optical ink matrix comprising:
a UV polymerizable monomer,
at least a first multifunctional monomer.

2. The optical ink of claim 1, wherein the optical ink matrix further comprises a second multifunctional monomer.

3. The optical ink of claim 2, wherein the first and second multifunctional monomer have different refractive indices.

4. The optical ink of claim 3, wherein the first and/or the second multifunctional monomer is UV polymerizable.

5. The optical ink matrix of claim 1, wherein the UV polymerizable monomer is chosen from a class of vinyl, methacrylate, and urethane.

6. The optical ink of claim 1, wherein the first multifunctional monomer is UV polymerizable.

7. The optical ink of claim 1, wherein the first multifunctional monomer takes the following form: 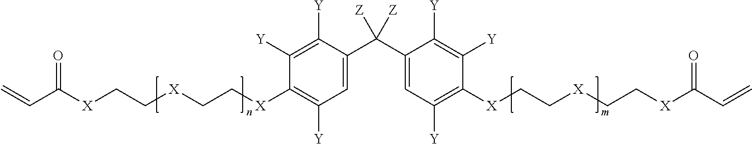
where X is Oxygen, Sulfur, or Nitrogen, Y is Hydrogen or a Halogen, and Z is a Hydrogen, a Halogen, a Phenyl group, or an Alkane.

8. A method of manufacturing GRIN lens using 3D printing comprising:
Predetermining a desired difference in refractive indices between 2 different multifunctional monomers in a Gradient Refractive Index (GRIN) lens;
Predetermining desired rheological properties of the GRIN lens.
Selecting 2 different multifunctional monomers based on the predetermined difference in refractive indices;
Manufacturing the GRIN lens using the 2 different multifunctional monomers;
Measuring the GRIN lens rheological properties and comparing the measured rheological properties of the predetermined desired rheological properties of the GRIN lens.

9. The method of claim 8, further comprising reselecting the multifunctional monomers.

10. The method of claim 8, further comprising varying the ratio of the 2 multifunctional monomers.

11. The method of claim 8, further comprising using monomers containing phenyl functionality to raise the refractive index above that which can be achieved by monomers containing only C, O, and H.

12. The method of claim 8, further comprising using monomers containing hetero-atoms chosen from a list of hetero-atoms containing sulfur and halogens to raise the refractive index above that which can be achieved by monomers containing only C, O, and H.

13. The method of claim 8, further comprising using monomers containing fluorine to lower the refractive index below that which can be achieved in monomers containing only C, O, and H.

14. A chemical composition comprising:
a UV polymerizable monomer,
a first and second optical ink,
wherein each of the first and second optical inks comprises a multifunctional monomer,
wherein the multifunctional monomer in the first optical ink has a different chemical structure than the multifunctional monomer in the second optical ink.

15. The chemical composition of claim 14, wherein the UV curable monomer is chosen from a class of vinyl, methacrylate, and urethane.

16. The chemical composition of claim 14, wherein the multifunctional monomer of the first optical ink is UV polymerizable.

17. The chemical composition of claim 14, wherein the multifunctional monomer of the second optical ink is UV polymerizable.

18. The chemical composition of claim 14, wherein the multifunctional monomer of the first optical ink has a different refractive index than the multifunctional monomer of the second optical ink.

19. The chemical composition of claim 14, wherein the multifunctional monomer of the first optical ink takes the following form: 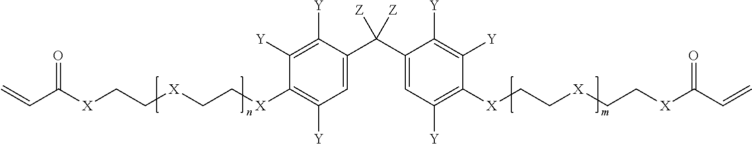
where X is Oxygen, Sulfur, or Nitrogen, Y is Hydrogen or a Halogen, Z is a Hydrogen, a Halogen, a Phenyl group, or an Alkane, and m is a positive integer.

20. The chemical composition of claim 14, wherein the multifunctional monomer of the second optical ink takes the following form: 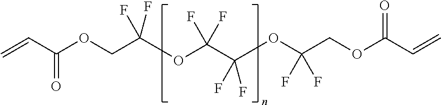
where n is a positive integer.
